(19) United States
(12) Patent Application Publication
(10) Pub. No.: US 2012/0167206 A1
(43) Pub. Date: Jun. 28, 2012

(54) SYSTEM AND METHOD FOR ENABLING SECURE DISPLAY OF EXTERNAL IMAGES

(75) Inventors: Markus REETZ-LAMOUR, Walldorf (DE); Rainer BAUREIS, Wiesloch (DE); Philipp STEVES, Sandhausen (DE)

(73) Assignee: SAP AG, Walldorf (DE)

(21) Appl. No.: 12/976,540

(22) Filed: Dec. 22, 2010

(51) Int. Cl. G06F 21/00

(52) U.S. Cl. 726/22

(57) ABSTRACT

A system and method for securely displaying to a user images retrieved from an external image source. Upon the request for a product catalog by the user via a user interface a backend retrieves images for the product catalog from external image sources and converts the retrieved images to render inoperable potentially malicious code embedded in the images. The converted images may then be used in the product catalog displayed to the user via the user interface. In an embodiment, the frontend compiles the product catalog and requests images from the backend. Product catalog information may be stored in a database implemented at the backend.

### BACKGROUND

Aspects of the present invention relate generally to the field of network security, and more specifically to securely retrieving data from a potentially unsecure source and delivering the data to a user interface.

A collection of products available for purchase and presented to a consumer is conventionally known as a product catalog. A product catalog may contain details about the products for sale from a retailer to assist the consumer in making a purchasing decision, including information concerning the products for sale and images of the products. Conventional product catalogs comprised products from a single retailer and were presented to the consumer in a printed, paper format. Modern product catalogs take advantage of advances in electronic communication and are often presented to the consumer digitally via the Internet. Some such electronic product catalogs may contain product information for multiple retailers or may aggregate product information collected from multiple websites.

Websites and applications that display a catalog of products to a consumer may link to stored product information and images to update the products displayed in the catalog. Stored product information for display in an online product catalog may be stored at a memory storage device, for example, local memory on a server that compiles and delivers the catalog to the consumer. Alternatively, the stored product information may be stored at an external storage device. The linked-to information may be updated in real time in order to present accurate information to the consumer, for example, by updating inventory or pricing data displayed in the catalog. Therefore, because the product information may become outdated or obsolete quickly and irregularly, it may be important to collect the information from storage when the user requests the catalog, and not before.

However, linking to data and images from external sources may pose a security risk from malicious code implanted in the retrieved data or image. The malicious code may then be inadvertently executed when the catalog is compiled or displayed and thereby compromise the consumer's computing system or the device that compiles and delivers the catalog to the consumer. To avoid such security risks, conventional security measures often include a thorough screening of each retrieved image or object. Such security measures involve significant resources and require too much time to be effectively performed upon a request for the catalog but before the catalog is displayed to the requestor. Accordingly, there is a need in the art for a system and method that efficiently and securely display objects and images retrieved from external sources.

### BRIEF DESCRIPTION OF THE DRAWINGS

FIG. 1 is a functional block diagram illustrating components of an exemplary system according to an embodiment of the present invention.

FIG. 2 is a simple block diagram illustrating components of an exemplary system according to an embodiment of the present invention.

FIG. 3 is a simple block diagram illustrating components of an exemplary system according to an embodiment of the present invention.

FIG. 4 illustrates an exemplary method for securely retrieving images from an external resource according to an embodiment of the present invention.

FIG. 5 illustrates an exemplary method for securely retrieving images from an external resource according to an embodiment of the present invention.

### DETAILED DESCRIPTION

Embodiments of the present invention provide a system and method that securely display image content to a user, for example, in a product catalog. The catalog may be compiled in real time upon the request of the user and displayed without significant delay. According to one aspect of the invention, the system has a frontend to interface with the user and a backend to manage the product information for the product catalog. The frontend may request an image from the backend and the backend will manage retrieval of the image from an external source and conversion of the image from a first image format to a second, different image format. The system and method convert the image to render inoperable potentially malicious code embedded in the image. The converted image may then be safely and efficiently displayed to the user as part of the product catalog. Therefore, any security risks conventionally encountered when retrieving images from an external source with unknown security are mitigated by the conversion. Further, extensive security measures that would hamper the effective delivery of product catalog information in real time are circumvented.

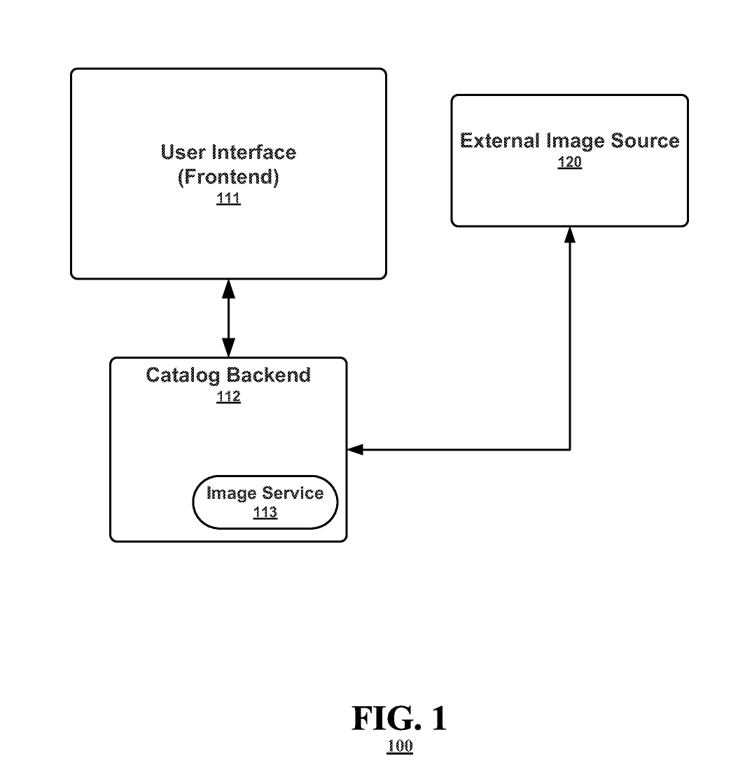

FIG. 1 is a simple functional block diagram illustrating components of an exemplary system 100 according to an embodiment of the present invention. As shown, system 100 may include a user interface (UI) 111, a catalog backend 112 having an image service 113, and an external image source 120. A user may access a catalog of products via the UI 111. The UI 111 may be a program or application, may comprise middleware, or may run on a computing device accessible to the user, that acts as a frontend to the catalog and facilitates access to the catalog backend 112 by delivering the product catalog to the user. The user may interact with the UI 111 through an input device, such as by inputting a selection as with a mouse or inputting a request as with a keyboard and observe the results of the request on an output device or display. In accordance with an aspect of the invention, the UI 111 may run in a browser window controlled by the user.

The catalog backend 112 may be implemented on a single-user computing system, a server, or a processor having access to a local memory device. The catalog backend 112 may comprise an application, for example a database that the user may access indirectly via the UI 111. The catalog backend 112 may be implemented on a computing device operable to compile the catalog, for example a server, and may further include an image service 113. The catalog backend 112 may additionally comprise data storage for storing catalog related data, and middleware to facilitate the interaction between the user interface 111, the catalog backend 112, and the external image source 120. The UI 111 may then render the product catalog for delivery to the user with the information received from the catalog backend 112. Some of the received information may be stored at a local memory device for later access by the UI 111.

The external image source 120 may be any data storage device that is beyond the direct control of the UI 111 or catalog backend 112 on which images that may be used in the catalog may be stored, for example, a network server. The image service 113 may facilitate secure retrieval of the stored images and display of the catalog to the user.

Conventionally, the UI 111 directly requests images from an external image source to populate a user-requested catalog. However, as noted above, this may create a security risk. To counter such security risks, communication with the external image source 120 may be restricted to Hypertext Transfer Protocol Secure (HTTPS). However, even with HTTPS, the images may not be stored securely, thus the security risk persists.

To securely display images in the catalog without instigating significant security measures, the catalog backend 112 retrieves product catalog images from the external image source 120 and converts the image from the retrieved format to a different image format. In accordance with an aspect of the invention, the UI 111 may have access to catalog data stored in local memory storage. The UI 111 may then compile the product catalog from the information stored in local memory, upon the request of the user. When the compilation of the product catalog involves retrieving an image from an external image source 120, the UI 111 may request the image from the catalog backend 112. This request may include the location of the requested image, for example, by passing the URL of the image at the external image source 120 to the catalog backend 112 as a parameter of the request. The request may be in the form of an HTTP or HTTPS request, (e.g. a GET request) with the URL as a parameter.

In accordance with another aspect of the invention, the product catalog information may be stored at the catalog backend 112, for example in a database stored in local memory. Then, upon a request from the user for a product catalog, the UI 111 may receive the information for the requested product catalog from the catalog backend 112. The UI 111 may then request images from the catalog backend 112 while rendering the requested product catalog. The request may include the location of the requested image or the location at the external image source 120 of a file containing the image. For example, the UI 111 may pass the URL of the image at the external image source 120 to the catalog backend 112 as a parameter of the request. According to an aspect of the invention, the request may be in the form of an HTTP or HTTPS request, with the URL as a parameter.

The catalog backend 112, through the image service 113, may retrieve the requested image from the external image source 120. Upon receipt of a requested image from the external image source 120, the catalog backend 112 may convert the image. In accordance with an aspect of the invention, the image service 113 may be implemented as a new node of the communication framework. The image service 113 may handle requests with the URL of the requested image received as a parameter. The image service 113 may then retrieve the image from the external URL corresponding to the external image source 120 and convert the image. The converted image may be passed to the UI 111 and may then be displayed to a user as part of the product catalog. According to an aspect of the invention, the response may be in the form of an HTTP or HTTPS response. The rendered product catalog may then be delivered to the user via the UI 111.

In accordance with another aspect of the invention, the UI 111 may pass the request for a product catalog to the catalog backend 112. The catalog backend 112 may then compile the requested catalog, including retrieving any needed images, and return the compiled catalog to the UI 111 to be rendered and delivered to the user. To compile the product catalog, the catalog backend 112 may access product information stored in local memory, in a database for example, and may retrieve from the external image source 120 the images according to the stored catalog data.

Regardless of the image format of the image retrieved from the external image source 120, the image may be converted into another known format at the catalog backend 112. For example, the conversion may be from the JPEG image format to the PNG image format or from any other image format to the JPEG format. The conversion renders malicious code inoperable. Then, the images displayed in the product catalog presented to the user may be free of unsecure or otherwise potentially harmful content.

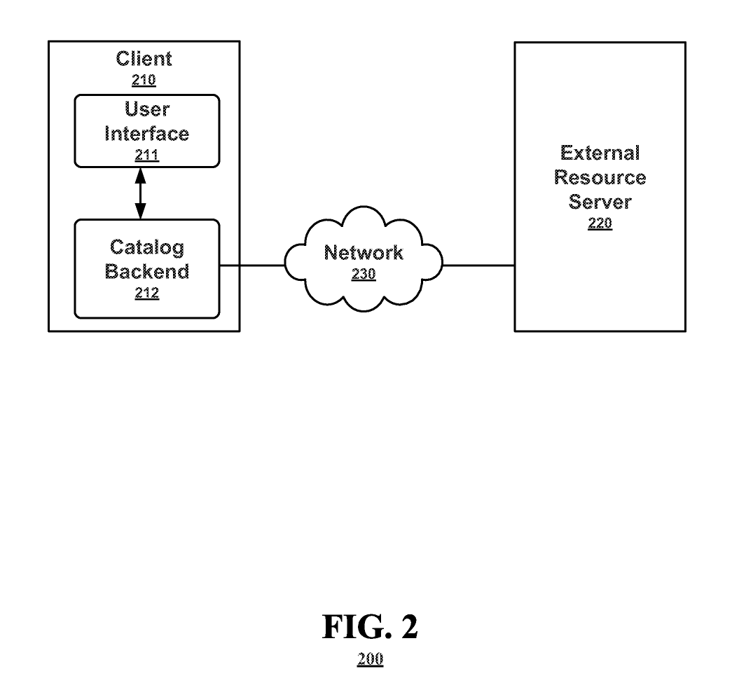

In accordance with one aspect of the invention, a user may operate the application in a client-server environment, or a networked environment, as would be well known to ordinarily skilled artisans. FIG. 2 is a simple block diagram illustrating components of an exemplary system 200 according to an embodiment of the present invention. As shown in FIG. 2, system 200 may comprise a client 210 having a user interface (UI) 211 and a catalog backend 212. The client 210 may be connected to a server 220 via a network 230. A user may access a product catalog with the client 210 having a UI 211 capable of accessing and displaying the catalog. The client 210 may deliver the product catalog to the user via the UI 211.

The client 210 may be any computing system that facilitates the user accessing the catalog backend 212, for example a personal computer or mobile handheld computing device. As shown, the client 210 and the catalog backend 212 may be implemented on a single computing device. The network 230 may be a wired or wireless network that may include a local area network (LAN), a wireless area network (WAN), the Internet, or any other network available for accessing the catalog backend 212 with the UI 211.

The external resource server 220 may be a server connected to the client 210 via the network 230 that stores images that may be part of the product catalog. The UI 211 may receive from the user a request for a catalog that the catalog backend 212 may respond to by displaying an appropriate product catalog. Then, as part of the request for a catalog, the client 210 may request images stored at the external resource server 220 via the catalog backend 212. The catalog backend 212 may retrieve the requested images from the external resource server 220. Upon receipt of a requested image from the external resource server 220, the catalog backend 212 may convert the image, rendering any malicious code inoperable and removing any otherwise harmful content. The converted image may then be used in a product catalog displayed to the user.

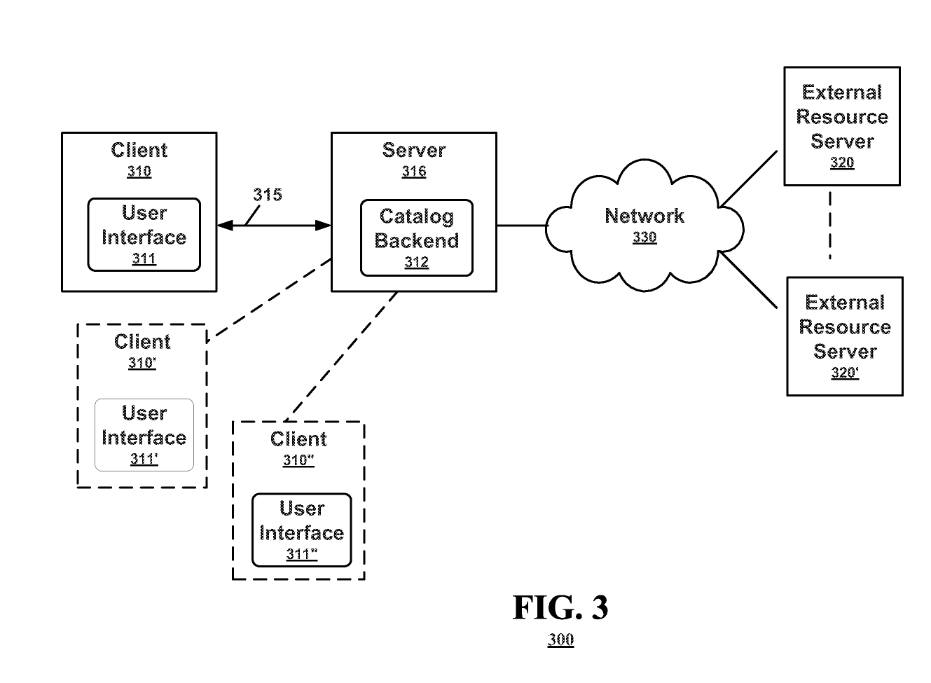

FIG. 3 is a simple block diagram illustrating components of an exemplary system 300 according to an embodiment of the present invention. As shown in FIG. 3, system 300 may comprise a plurality of clients 310-310″, a server 316, and a plurality of external resource servers 320-320′. Client 310 may be a computing device connected to a server 316 via a wired or wireless network connection 315. As shown, the client 310 with UI 311 and the catalog backend 312 may be implemented on separate computing devices. The client 310 may include the UI 311 by which the user may access the product catalog. The server 316 may implement the catalog backend 312. The network connection 315 may be implemented via a wired or wireless network that may include a local area network (LAN), a wireless area network (WAN), the Internet, or any other network available for connecting the client 310 and the UI 311 with the catalog backend 312 at the server 316.

The external resource server 320 may be a server connected to the server 316 via the network 330. The external resource server may store images that may conventionally be requested by the client 310 to display the product catalog. The client 310 may request images stored at the external resource server 320 via a request sent to the catalog backend 312 at the server 316. The request may contain the URL of the image as a parameter. According to an aspect of the invention, the request may be in the form of an HTTP or HTTPS request. The catalog backend 312 may forward the request to the external resource server 320 via the network 330. Upon receipt of a requested image from the network 330, the catalog backend 312 at the server 316 may convert the image, rendering any malicious code inoperable and removing any otherwise harmful content. The converted image may then be passed back to the client 310 and the user interface 311 via the network connection 315 for display to the user. According to an aspect of the invention, the response may be in the form of an HTTP or HTTPS response.

Optional additional user interfaces 311′-311″ may be implemented to display product catalogs to multiple users on different clients 310′-310″. The plurality of user interfaces 311-311″ may access a single catalog backend 312.

Optional additional external resource servers 320-320′ may be accessed to retrieve a plurality of images. Not all images requested for a product catalog may be stored at the same external resource server. Then a plurality of external resource servers 320-320′ may be accessed to retrieve the images requested for the product catalog. Alternatively, a single requested image may be available at multiple external resource servers. Then if the image retrieval from the first external resource server 320 fails, a second external resource server 320′ may be accessed to retrieve the requested image.

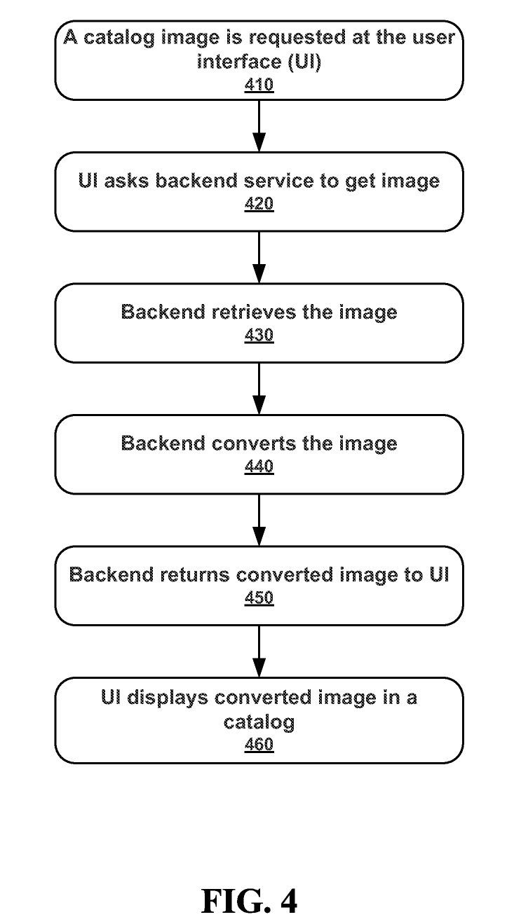

FIG. 4 illustrates an exemplary method for securely retrieving images from an external resource. A user interface may display to a user a product catalog comprising images of products that may be sold or licensed or otherwise offered to the user. To securely display images in the product catalog without instigating lengthy and expensive security measures, a user at the user interface may request a product catalog. To complete this request, an image retrieved from an external image source may be required (block 410). The image may be retrieved with a request to the backend supporting the user interface (block 420). The request may include the location corresponding to an external image source where the image may be stored, for example a file containing the image at a network server. If the location is not part of the request, the backend may have access to the location of the image that may be retrieved from product information stored in local memory, for example, by querying a database.

An image service may retrieve the requested image from the external image source (block 430). Upon receipt of a requested image from the external image source the image service may convert the image to another image format (block 430). Any image format known in the art may be used for the conversion. This may include, but is not limited to: JPEG, PNG, GIF, TIFF, BMP, etc. For example, an image retrieved in JPEG may be converted to PNG and an image retrieved in GIF may be converted to JPEG. The converted image may then be returned to the user interface (block 450) and displayed as part of the catalog (block 460).

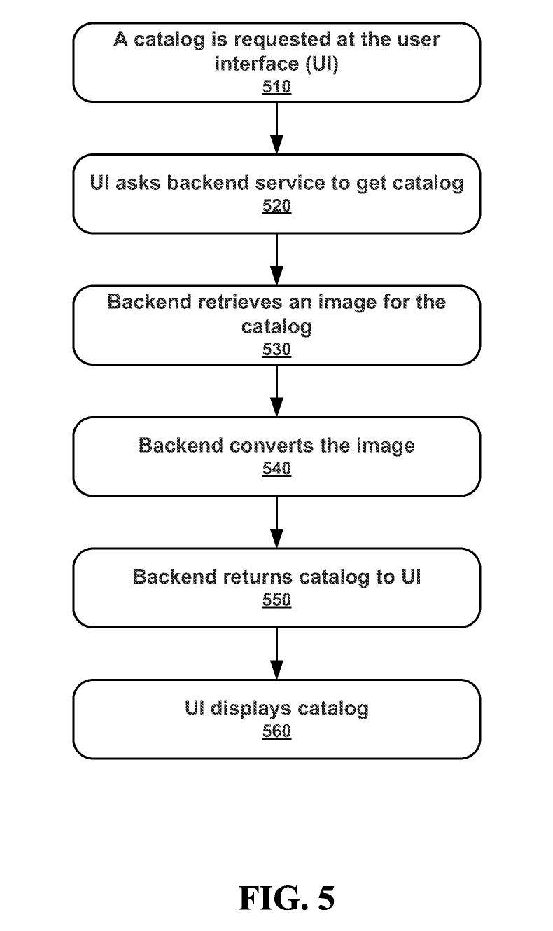

FIG. 5 illustrates an exemplary method for securely retrieving images from an external resource. Upon the request of a user, a user interface may render a product catalog for display to the user, where the catalog comprises images of products to be retrieved from external sources (block 510). To securely display images in the product catalog without instigating lengthy and expensive security measures, a user interface displaying the product catalog may request the product catalog from a backend or server (block 520). To complete this request, an image may be retrieved from an external image source (block 530). The location of the image may be a URL retrieved from product information stored in local memory, for example, by querying a database.

Upon receipt of a requested image from the external image source an image service may convert the image to another image format (block 540). Any image format known in the art may be used for the conversion. The converted image may then be used in the product catalog and the product catalog may be returned to the user interface (block 550) to be rendered and displayed to the user (block 560).

The foregoing discussion identifies functional blocks that may be used in image display systems constructed according to various embodiments of the present invention. In practice, these systems may be applied in a variety of devices, such as personal computing systems and/or mobile devices. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, not all of the functional blocks described herein need be provided or need be provided as separate units. For example, although FIG. 1 illustrates the components of an exemplary computing system, such as the user interface 111 and the catalog backend 112 as separate units, in one or more embodiments, they may be integrated. Such implementation details are immaterial to the operation of the present invention unless otherwise noted above.

Furthermore, although the above embodiments are described with reference to a product catalog, as will be apparent to one of ordinary skill in the art, aspects of the present invention may have application for any user interface connected to a backend that displays images retrieved from external sources.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A computer implemented method for securely displaying an image to a user on a display comprising:
upon receipt of a request for the image at a server, retrieving the image from a source external to the server, wherein the request comprises a location of a file containing the image at the source external to the server;
converting the retrieved image from a first format to a second format; and
returning the converted image in a response;
wherein the first format and the second format are different formats.

2. The method of claim 1 further comprising: querying a database to identify the source external to the server.

3. The method of claim 1 wherein the request comprises a URL identifying the source external to the server.

4. The method of claim 1 wherein one of the first format and the second format is JPEG.

5. The method of claim 1 wherein the request is an HTTP/HTTPS request.

6. The method of claim 1 wherein the response is an HTTP/HTTPS response.

7. A computer implemented method for securely displaying a product catalog to a user on a display comprising:
upon receipt of a request from a user for a product catalog, compiling the requested catalog;
said compiling comprising:
sending a request for an image to a backend wherein the request comprises a location of a file containing the image at a source external to the backend; and
receiving the requested image from the backend as a response;
wherein the requested image has been converted from a first format to a second different format;
wherein the image is retrieved from the source external to the backend in the first format;
displaying the compiled product catalog to the user.

8. The method of claim 7 wherein the image request comprises a URL.

9. The method of claim 8 wherein the image request is an HTTP/HTTPS request.

10. The method of claim 7 wherein the response is an HTTP/HTTPS response.

11. A computer implemented method for securely displaying a product catalog to a user on a display comprising:
upon receipt of a request from a user for a product catalog:
forwarding the request for the product catalog to a backend;
retrieving with the backend an image in a first format from a source external to the backend; and
converting the image with the backend from the first format to a second different format;
receiving the requested product catalog from the backend; and
displaying the product catalog to the user.

12. A system comprising:
a frontend operable to display a product catalog to a user; and
a backend operable to retrieve an image from an external source;
wherein the frontend requests the image via the backend and the backend converts the retrieved image from a first format to a second different format and delivers the converted image to the frontend.

13. The system of claim 12 wherein the request comprises a URL identifying the external source.

14. The system of claim 12 wherein the request is an HTTP/HTTPS request.

15. The system of claim 12 wherein the backend delivers the converted image to the frontend with an HTTP/HTTPS response.

16. The system of claim 12 further comprising a database to store information for a plurality of products in the product catalog.

17. The system of claim 16 wherein the frontend retrieves a location of the image from the database.

18. The system of claim 16 wherein the backend retrieves a location of the image from the database.

19. The system of claim 12 further comprising an image service module that manages the retrieval and conversion of the image by the backend.

20. The system of claim 12 wherein the frontend comprises a browser.

21. The system of claim 12 wherein the backend comprises a server.

22. A system comprising:
a frontend operable to display a product catalog to a user; and
a backend operable to compile the product catalog and deliver the product catalog to the frontend;
wherein compiling the product catalog comprises retrieving an image from an external source and converting the retrieved image from a first format to a second different format.

23. The system of claim 22 further comprising an image service module that manages the retrieval and conversion of the image by the backend.

24. The system of claim 22 further comprising a database to store information for a plurality of products in the product catalog.

25. The system of claim 24 wherein the frontend retrieves a location of the image from the database.

26. The system of claim 24 wherein the backend retrieves a location of the image from the database.
